(19) United States
(12) Patent Application Publication
(10) Pub. No.: US 2025/0061505 A1
(43) Pub. Date: Feb. 20, 2025

(54) CUSTOMIZATION OF REPLACEMENT ITEMS USING MODEL WITH CONTEXTUAL FEATURES

(71) Applicant: Maplebear Inc., San Francisco, CA (US)

(72) Inventors: Sharath Rao Karikurve, Berkeley, CA (US); Ramasubramanian Balasubramanian, Jersey City, NJ (US)

(21) Appl. No.: 18/233,826

(22) Filed: Aug. 14, 2023

(51) Int. Cl. G06Q 30/0601; G06F 40/40; H04L 51/046

(52) U.S. Cl. CPC G06Q 30/0631; G06F 40/40; G06Q 30/0629; H04L 51/046

(57) ABSTRACT

An online concierge system scores candidate replacement items for an ordered item that is not available for delivery. A set of contextual features may be generated describing the user and/or the order in which the item is being replaced, enabling the recommended items to be evaluated with additional context and more-correctly evaluate whether a customer will accept a replacement item, particularly when the replacement item is selected by a picker or the online concierge system. In addition, as candidate replacement items may receive feedback from the customer in different contexts, during training the candidate items may be labeled with different values according to a hierarchy based on the particular feedback and context provided by the user.

### BACKGROUND

This disclosure relates generally to ordering an item through an online concierge system, and more specifically to identifying candidate replacement items for an ordered item by the online concierge system.

In current online concierge systems, shoppers (or “pickers”) fulfill orders at a physical warehouse, such as a retailer, on behalf of customers as part of an online shopping concierge service. In current online concierge systems, the shoppers may be sent to various warehouses with instructions to fulfill orders for items, and the shoppers then find the items included in the customer order in a warehouse. Item inventory at a warehouse may fluctuate throughout a day or week, so a shopper may be unable to find an item ordered by a customer at a warehouse.

To account for varying availability of an item that a customer ordered at a warehouse, an online shopping concierge service may prompt a customer to identify a replacement item for the item. However, appropriately selecting and suggesting such replacement items may be difficult to effectively provide to the user while balancing other considerations. In particular, systems that suggest items based on item similarity may be effective for the general case, but may neglect to customize the replacement item suggestions according to the particular shopper and the particular order for which the replacement item is selected. That is, prior systems may suggest items based on item-item similarity between the ordered item (the item to be replaced) and a candidate replacement item, but without effective consideration of what this particular customer may accept as a replacement for this particular order. In many circumstances, shoppers have a limited time at the warehouse in which the order is being fulfilled to determine a replacement item. Particularly when the customer is unable to review and approve/reject a particular replacement item before the shopper leaves the warehouse, errors in replacement item selection may result in more significant degradation in effective service. The customer may not receive any replacement when a suitable replacement item was available or the customer may receive a replacement that is not suitable for the customer's current order. Improving replacement item evaluation by the online concierge system can significantly increase the likelihood that, when the user receives a replacement item, it is the correct one for that order by that user.

Effective replacement order selection and evaluation may also be difficult because different users have different preferences for replacements and because different users may prefer different replacements at different times. For example, a shopping order may include ingredients for a particular recipe for which a particular replacement item is not suitable even though the replacement item may often be a good replacement for the ordered item. As such, replacement item evaluation by a concierge system may be improved by effectively addressing these challenges of existing systems.

### SUMMARY

In accordance with one or more aspects of the disclosure, an online concierge system analyzes replacement items for an ordered item with a computer model that includes contextual features describing the particular situation for which the replacement items are evaluated. The contextual features may be used in conjunction with features, such as embeddings, describing the unavailable item to be replaced and the candidate replacement items. While the features related to the unavailable item (i.e., the ordered item being replaced) and the replacement item may be effective for generally describing whether the replacement items are suitable replacements, including contextual features allows the suggestion to be customized to the particular situation, such as the user placing the order and the other items in the order.

When an order is being fulfilled by a picker, the picker may identify an item as unavailable for fulfillment. The online concierge system receives an identification of the item and identifies the order along with the item being replaced to evaluate candidate replacement items. The candidate replacement items may be selected by a candidate replacement item selection process, for example based on item categories, brands, embeddings, and so forth. A set of contextual features are identified that describe the context in which the replacement item is to be selected. The contextual features may describe user features, such as a user's price and brand sensitivity, brand preferences, and prior user orders. The contextual features may also include additional characteristics of the location at which the order is fulfilled, along with characteristics of the other items in the order. The other items in the order may be used, for example, to infer whether other items may be suitable in the context of the order, for example, to be used together in a recipe. In one or more embodiments, the other items are modeled as a “bag-of-words” in which the other ordered items are present and the replacement item is predicted with respect to whether it belongs with the other items in the order. In some embodiments, the contextual features may also include information based on real-time messages between the picker and the ordering user. By including the additional contextual features as an input to a computer model, the computer model may score the candidate replacement items based on the additional context so that the replacement item is more likely to be acceptable to the ordering user. This may significantly increase performance (e.g., by reducing rejected orders) for selected replacement items, particularly when the replacement item must be selected without the ordering user's involvement (the picker has a limited time to select the replacement and does not receive information from the customer before selecting the replacement).

As candidate replacement items may not always be presented to users, training data items may be labeled with different values depending on the context in which the user provided feedback. That is, “positive” and “negative” training data items may have values that differ based on the type of feedback an ordering user provided. For example, a candidate replacement item may be selected by a picker and presented to the ordering user. The replacement item may be accepted or rejected by the user in accepting the fulfilled order. A replacement item accepted by the user but selected by the picker may be labeled with a different value for training than a replacement item selected by the user when viewed with additional items that were not selected by the user. As such, different training items may have different labels in a hierarchy based on the different user interactions with the candidate replacement items. Training the computer model based on these different label values allows the computer model to effectively generate replacement suggestions with contextual features that accounts for the different situations in which the user may select or accept replacement items for an order.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 shows a timing diagram for suggestion of replacement items, in accordance with one or more embodiments.

FIG. 4 is a flowchart of a method for evaluating candidate replacement items with a computer model based on contextual features, in accordance with one or more embodiments.

FIG. 5 illustrates an example of labeling items for training the computer model for replacement item scoring, in accordance with one or more embodiments.

### DETAILED DESCRIPTION

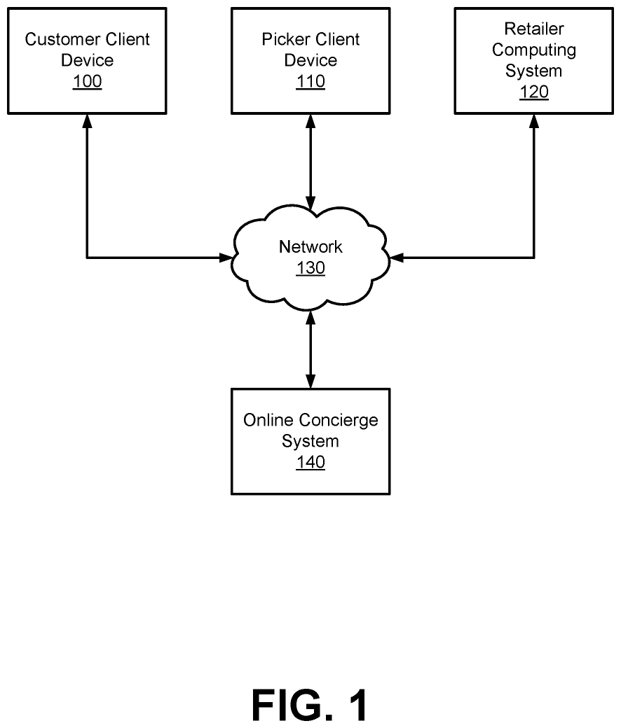

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Customers may also be referred to as “ordering users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit (SKU) or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

In some cases, the picker may be unable to locate one or more items in the order at the location. These items may be out-of-stock at the location, no longer carried by the location, or otherwise unavailable for inclusion for delivery with the order. In these circumstances, a replacement item may be determined to replace the ordered item (also termed an “unavailable item”) for delivery with the order. The online concierge system 140 may evaluate candidate replacement items and suggest one or more of the candidate replacement items for selection as the replacement for an unavailable item. The suggested replacement items may be provided to a customer when the order is placed (e.g., for an item that is likely to be out-of-stock) or may be provided to a picker or customer after a picker determines the ordered item is not available. When the ordered item is unavailable, a selected replacement item may be provided as a replacement. As discussed further below, candidate replacement items may be evaluated by the online concierge system with a computer model that includes contextual features that may customize the scoring of replacement items to the particular order and/or customer associated with the order, improving the likelihood that the suggested replacement items will be accepted for delivery by the user.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

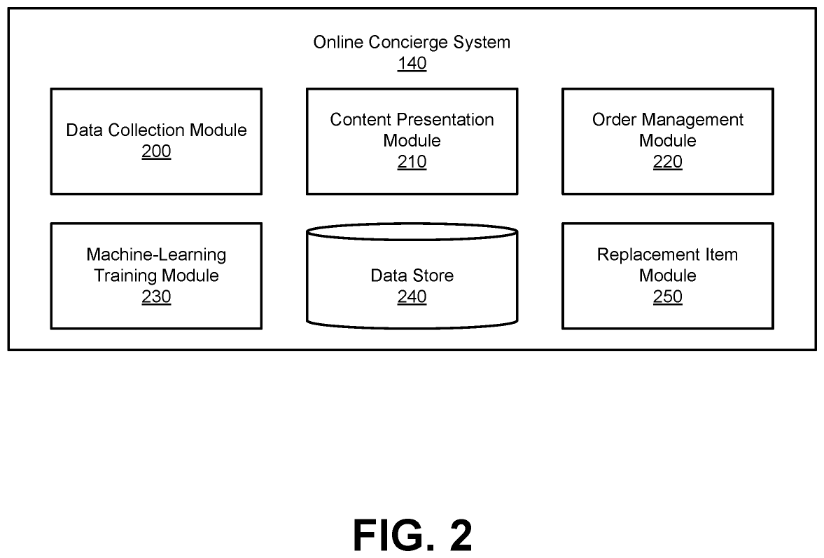

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, a data store 240, and a replacement item module 250. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of the order. In some embodiments, the order management module 220 computes an estimated time of arrival of the picker to the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, hierarchical clustering, and neural networks. Additional examples also include perceptrons, multilayer perceptrons (MLP), convolutional neural networks, recurrent neural networks, sequence-to-sequence models, generative adversarial networks, and transformers. A machine-learning models may include components relating to these different general categories of model, which may be sequenced, layered, or otherwise combined in various configurations.

Each machine-learning model includes a set of parameters. The set of parameters for a machine-learning model are used to process an input and generate an output. For example, a set of parameters for a linear regression model may include weights that are applied to each input variable in the linear combination that comprises the linear regression model. Similarly, the set of parameters for a neural network may include the respective weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes a set of input data for which machine-learning model generates an output. For example, each training example may include customer data, picker data, item data, or order data. In some cases, the training examples also include a label which represents an expected output (i.e., a desired or intended output) of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model, whereby the machine-learning training module 230 updates parameters of the machine-learning model based on each of the set of training examples. The training examples may be processed together, individually, or in batches. To train a machine-learning model based on a training example, the machine-learning training module 230 applies the machine-learning model to the input data in the training example to generate an output with a current set of parameters. The machine-learning training module 230 scores the output from the machine-learning model using a loss function. A loss function is a function that generates a score for the output of the machine-learning model, such that the score is higher when the machine-learning model performs poorly and lower when the machine learning model performs well. In cases where the training example includes a label, the loss function is also based on the label for the training example. Example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory computer-readable media. The data store 240 uses computer-readable media to store data, and may use databases to organize the stored data.

The replacement item module 250 identifies ordered items that are unavailable for fulfillment and identifies replacement items to suggest for replacing the unavailable item. The replacement item module 250 may identify candidate replacement items, generate inputs for a computer model that scores the candidate replacement items, apply the computer model for the candidate replacement items, and suggest replacement items for the ordered item. The replacement item module 250 may operate in conjunction with the content presentation module 210 to present suggestions to customers and pickers on respective devices. The replacement item module 250 may also communicate with the order management module 220 for identifying items in an order, unavailable items in the order, and replacing items in an order with selected replacement items. To evaluate candidate replacement items, the replacement item module 250 may also apply a computer model that may be stored in data store 240 and trained in conjunction with the machine-learning training module 230.

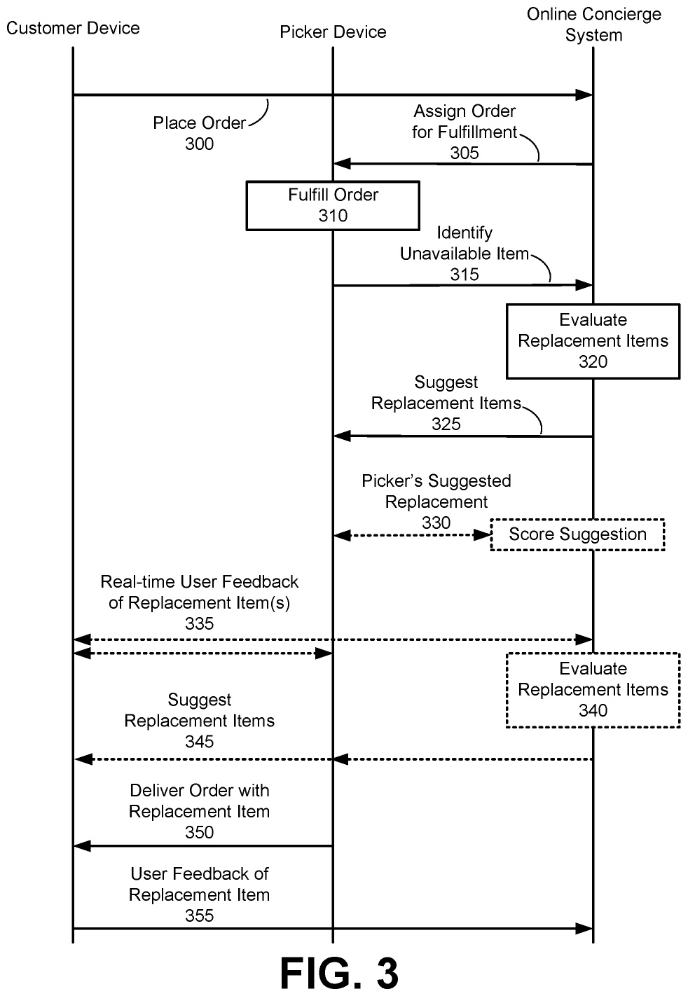

FIG. 3 shows a timing diagram for suggestion of replacement items, in accordance with one or more embodiments. The timing diagram of FIG. 3 shows example interactions between a customer device (operated by a customer), a picker device (operated by a picker) and an online concierge system. For convenience, operations performed by the customer and picker devices (in conjunction with the customer and picker) may be referred to as performed by the customer and picker respectively. Initially, the customer places 300 an order with the online concierge system, selecting a group of items to be fulfilled by a picker and delivered to the customer. In some embodiments, while selecting items for the order, the online concierge system may prompt the user to select a replacement item, for example, when an item has a sufficiently-high likelihood of being unavailable for fulfillment. The suggested replacement items may be provided to the user similar to the replacement items discussed below. In some instances, when an ordered item and the alternative item selected as a replacement are both unavailable, additional replacement items may be evaluated as discussed below.

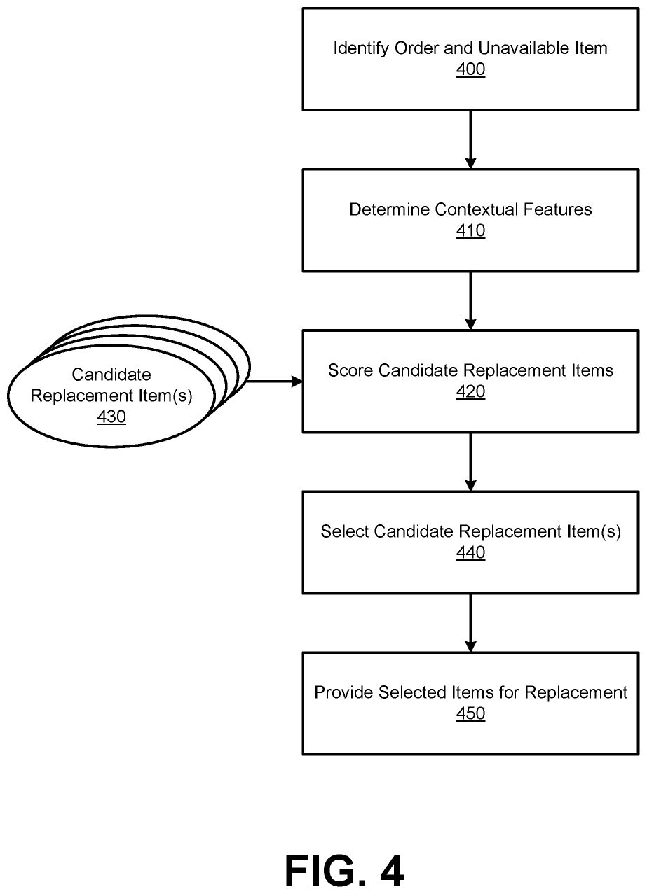

When the order is placed 300 by the user, the online concierge system assigns 305 the order for fulfillment by a picker. The order may be assigned in various ways in different embodiments, and may include the online concierge system selecting a picker or listing the order among available orders for selection by pickers. After a picker is assigned 305 to the order, the picker fulfills 310 the order at the location and begins collecting items. During fulfillment, the picker may identify 315 that an item in the order is unavailable for fulfillment and notifies the online concierge system that the item is not available. The online concierge system evaluates 320 replacement items and may suggest 325 replacement items to the picker as an alternative to the ordered item. To evaluate 320 the replacement items, the online concierge system may score a group of candidate replacement items based on a set of contextual features that may describe the particular order and/or user to receive the order, such that the replacement items are personalized. Details of the selection and scoring of candidate items are further discussed below, such as with respect to FIG. 4.

Candidate replacement items may be scored and provided to the picker and/or customer in a variety of different ways in various embodiments, which may include embodiments using any or all of these approaches. As noted above (not shown in FIG. 3), candidate replacement items may be scored and provided to the customer when the order is placed. In many instances, the replacement item may be suggested 325 for a picker to select at the location in lieu of the ordered item. By identifying a replacement item for the picker at the location, customers may still receive a delivery with replacement items that effectively substitute for the ordered items, preventing the customer from needing to place additional orders for an unavailable item. In many cases, however, the user may not have provided a replacement item when the order was placed or the initially-selected replacement item is not available. When the picker is at the location, the picker may often have a limited time to select replacements, and the customer may not be available to select a replacement item or provide feedback to a picker's selection of a replacement item. As such, in many cases the suggested 325 replacement items are sent to the picker to fulfill and/or select the replacement. By improving replacement item suggestions by accounting for contextual features as discussed below, pickers may more effectively select replacements acceptable to the user, enabling effective picker selection of replacements with a reduced likelihood of rejection by the user at delivery. In further examples, the picker may also select an item as a suggested replacement that differs from the items suggested 325 by the online concierge system. For example, in some situations the picker may identify an item that is in stock and available in inventory that was not known to the online concierge system (or otherwise not included in the candidate replacement items evaluated by the online concierge system). The picker's suggested replacement item may be sent 330 to the online concierge system for further evaluation and scoring by the online concierge system. The scoring may indicate, for example, a predicted likelihood that the user will accept the picker's suggested replacement item or a relative ranking of the picker's suggested replacement item relative to other potential replacement items (e.g., the suggested 325 replacement items).

As noted above, in one or more embodiments, the picker and/or the online concierge system may identify replacement items without further input from the customer. In further examples, the customer may have an opportunity to provide feedback on the replacement items to be selected for an unavailable item. When the customer responds to the opportunity, the customer may provide real-time feedback for selecting the replacement items. For example, the picker may engage in a real-time messaging session (e.g., via a messaging service) to provide information to the customer regarding the unavailable item. In some embodiments, the customer may view an interface of suggested replacement items for selection of a replacement; in other embodiments, the customer may interact with the picker directly. As such, in some embodiments, the customer may provide information about replacement items as real-time user feedback 335. The customer may describe the purpose of the item in the overall order and may provide information and/or criteria to the picker for selecting a replacement. For example, the customer may place an order for items that together include ingredients for a meal including chicken, rice, and corn. When the specified chicken item is not available, the real-time user feedback 335 may aid in identifying whether, for example, the user's preferred item to replace the specified chicken (e.g., 500 g of chicken breast) is another type of chicken (e.g., 500 g of chicken thighs or a whole chicken) or another meat altogether (e.g., pork chops). Different users and the same user at different times, may prefer different replacement items based on the other items in the order, what the user has available as alternatives, and so forth. Incorporating real-time user feedback may improve suggestions for different situations and aid pickers in selecting appropriate replacements. As discussed below, one input to the computer model may include features describing the real-time feedback between the customer and picker. The online concierge system may then evaluate 340 candidate replacement items based on the additional real-time information from the customer and suggest 345 replacement items to the customer or picker for replacing the unavailable item.

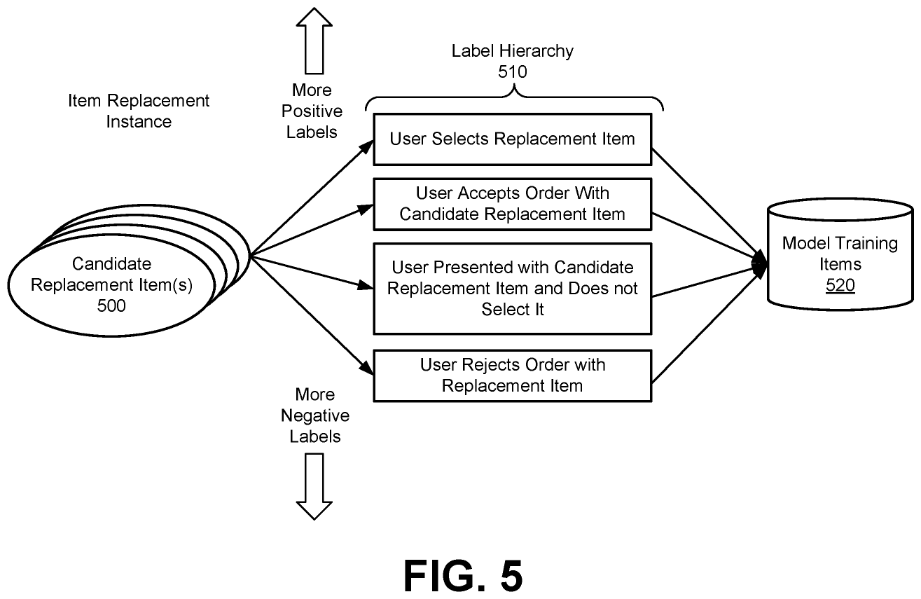

With one or more of these ways of selecting a replacement item, the picker may then complete the order at the location with the replacement item and deliver 350 the order with the replacement item to the customer. The customer may then provide 355 a response (e.g., feedback) regarding approval or rejection of the replacement item in the order. For example, in some circumstances, the replacement item may have been selected without further input from the customer, e.g., when selected by the picker or from evaluation by the online concierge system. Whether the user accepts or rejects the replacement item may provide effective feedback that may be used as training data for improving the computer model predictions of the candidate replacement items. As shown in FIG. 3, replacement items may be evaluated and suggested at various times points in various configurations: when the customer creates an order (particularly for items that are substantially likely to be out-of-stock), when an item is identified as out-of-stock by the picker fulfilling the order (with no designated replacement or where the designated replacement is unavailable), or in consideration of real-time messaging of the customer. In addition, the suggested items in different situations may be provided to the customer for selection (e.g., when creating an order or when the customer is available to select a replacement item when the picker is at the location) or may be provided to the picker. To more effectively evaluate candidate replacement items, the computer model may include contextual features about the user and/or the order as discussed in FIG. 4. In addition, and as discussed further with respect to FIG. 5, the different situations in which the customer may provide feedback with respect to the replacement item may also affect training of the computer model by labeling training data based on the particular situation in which the customer evaluated the replacement item.

FIG. 4 is a flowchart of a method for evaluating candidate replacement items with a computer model based on contextual features, in accordance with one or more embodiments. Alternative embodiments may include more, fewer, or different steps from those illustrated in FIG. 4, and the steps may be performed in a different order from that illustrated in FIG. 4. These steps may be performed by an online concierge system (e.g., the online concierge system 140). Additionally, each of these steps may be performed automatically by the online concierge system without human intervention.

Initially, an order is identified 400 along with an unavailable item for which to evaluate candidate replacement items 430. As discussed above, the unavailable item may include items that are likely to be unavailable, for example when a user orders an item that is sufficiently likely to be unavailable, the online concierge system may suggest replacement items when the order is placed such that the picker may automatically replace the ordered item if it is unavailable. Next, based on the order and/or user, a set of contextual features 410 is determined that may be used to customize the evaluation of candidate replacement items for the particular circumstance. The particular contextual features used may vary in different embodiments, and generally describe information in addition to the candidate items and the ordered item being replaced. The following contextual features may be used alone or in various combinations in different embodiments and/or configurations.

As one example, contextual features may include information describing the user placing the order. The user may be described with user features based on information provided by the user or inferred from prior user behaviors or actions with respect to the online concierge system. For example, the user's previous orders may be used to infer characteristics such as a user's price sensitivity, brand loyalty, prior items ordered by the user, prior replacement items selected by the user, a user's frequency of accepting replacement items, and so forth. In addition, the user may provide additional information, such as a user's income range, preference for types of items, and so forth. The various types of information may also vary according to the type of location and items coordinated by the online concierge system. For example, embodiments of the online concierge system that coordinate delivery of food or other grocery items may include information related to dietary preferences of the user and/or a user's general cooking experience or cooking style. In other examples, embodiments of the online system that coordinate delivery of electronics equipment may include information related to brand preferences for major electronics companies. As such, the user-related information may generally describe information about the user and/or the user's historical interactions that may beneficially be used to improve prediction of candidate replacement items for a particular item to be replaced for a particular order.

As another example, the contextual features may include features describing the current order in which the unavailable item is being replaced. For example, the other items in the order may be used to determine contextual features describing the order as a whole. In one example, the additional items in the order (i.e., the items other than the replacement item) may be identified and used to determine a representation of the order as a whole or to evaluate replacement items with respect to the other items represented as tokens or embeddings (e.g., with a bag-of-words model). For example, in one or more embodiments the computer model may use the other items as a part of a “sentence” for which candidate items are evaluated as an additional “word” to be included in the sentence. The contextual features for the order may thus include embeddings, tokens, categorical descriptions, or other characterizations of the order that may be used for evaluation of candidate replacement items in the context of the order as a whole. Additional information describing the particular order may also be included, such as the time of day and/or day of week in which the order is made.

As a further example, the contextual features may include features describing a real-time conversation or interaction between the customer and picker during fulfillment (e.g., messaging), such as after an item is identified as unavailable. The customer may describe, for example in free-form text, information about the order as a whole, the item being replaced, preferred or dispreferred replacement items (and/or characteristics thereof). Contextual features are determined from the real-time information by any suitable technique, such as with natural-language processing (NLP) analysis. Such analysis may determine characteristics or other features of items to replace the ordered item from the real-time messages and characterize real-time messaging as contextual features to be further processed by the computer model.

Using the contextual features 410, a set of candidate replacement items 430 may be scored as replacements for the ordered item in the current order. The set of candidate replacement items 430 may be determined, for example, based on the ordered item to be replaced and its similarity to other items available at the location. For example, a set of candidate items may be filtered based on a similarity score of item embeddings of the ordered item relative to items in the inventory of the location. A set of the items having the highest similarity score may be selected as the candidate replacement items 430 for further processing by the replacement item computer model scoring. In some embodiments, the set of candidate replacement items 430 may also be provided in conjunction with the similarity score, such that the scoring 420 may provide a re-scoring or re-ranking of the items based on item similarity.

Each of the candidate replacement items 430 may be scored 420 with a computer model based on a set of input features that may include features describing the ordered item, features describing the candidate replacement item, a similarity score between the candidate replacement item and the ordered item, and/or the contextual features. The computer model may be a logistical regression, neural network, or other type of computer model architecture with parameters that may be learned during a training process. The computer model may include multiple subcomponents that include different subcomponents. For example, contextual features related to other items in the order may be processed by a component that evaluates a candidate replacement item as an item in a bag-of-words model with respect to other items in the order, such that the output of the bag-of-words model (which may represent the candidate replacement item with respect to other items in the order) may then be an input to a further layer that processes additional information related to the candidate replacement item.

The scoring of the candidate replacement items in conjunction with the contextual features may then be used to select 440 one or more candidate replacement items. To select the items, the candidate replacement items may be ranked based on the scoring and selected based on the ranking. A number of items selected may vary in different implementations and embodiments. For example, the number of items to suggest may be determined based on a number of positions available to display on a user's interface. In some embodiments, the number of items selected is one item, such as when the online concierge system determines the replacement item and provides the replacement item to the picker. Finally, the selected items are provided 450 to the picker or customer, for example, to confirm or select a replacement item for the order. Optionally, the scores for the selected candidate replacement item(s) is also provided, for example to a picker to select an item and consider the expected difference in predictions for each item. In some embodiments, an item is provided for scoring, for example by a picker, for evaluation by the computer model as a single candidate replacement item and the score for the item may be provided to the picker for consideration. In addition, the score for an item provided by a picker may be provided in addition to scores of other items such that the predicted score of the item can be considered by the picker in conjunction with the scores for other items.

FIG. 5 illustrates an example of labeling items for training the computer model for replacement item scoring, in accordance with one or more embodiments. In general, the computer model may be trained to score candidate replacement items with respect to the likelihood that the customer will accept the replacement item. In some cases, the candidate replacement items are provided to the picker, such that the customer receiving the item may not directly provide feedback with respect to items other than the item actually selected as a replacement when the customer accepts or rejects the replacement item when it is delivered. In other circumstances, the customer may be directly provided a number of candidate replacement items in an interface of which one is selected as the replacement item. As such, these different circumstances may provide different information related to the preference of customers for the different replacement items. As such, replacement items for ordered items may be labeled with different values in training depending on the type of feedback provided by the user (e.g., and the context in which the user provided the feedback). The different values may be represented as a label hierarchy 510.

For candidate replacement items 500, training data is generated by labeling the items according to the label hierarchy 510. For example, a customer that selects a candidate item as a replacement may be assigned the highest value in the hierarchy, such as a value of 1. When a replacement item is selected for an order, e.g., by the picker, and the customer accepts the replacement item without viewing or evaluating alternatives (e.g., the picker or the online concierge system selected the replacement item), this positive feedback may be valued differently during training. For example, the customer accepting an order having a replacement item may provide a value of 0.8 to the replacement item during training. This item may be labeled differently than the customer viewing and selecting from a group of candidate replacement items because, for example, the user is presented with a binary choice of whether to accept or reject the replacement item and thus may not represent the “best” replacement item, while the customer-selected item (from among several) may represent a more-preferred option relative to the other candidate items. Likewise, when a user rejects an order with an already-selected replacement item, it may indicate the item is not an acceptable replacement, rather than a “less-preferred” replacement. Thus, the user rejecting a delivered item may be labeled with a more negative label relative to a user presented with a candidate replacement item and selecting another item (i.e., not selecting a presented candidate item as a replacement).

Based on the labels, model training items 520 may be generated with the features available for the order, user, and items, with a target score for the computer model based on the label. Using the features associated with each training item and the label values, the computer model is trained to predict the label values. The computer model may be trained with any suitable training approach, such as gradient descent.

By including contextual features, the computer model may learn parameters that customize scoring for the candidate replacement items according to the particular conditions of the order. This may permit replacements to account for the item being replaced, the customer receiving the order, and other contextual information of the order. In addition, as the replacement items may be selected by the online concierge system and/or the picker (e.g., predicting what may be acceptable to the customer receiving the delivery), these additional features improve the likelihood that the replacement item is acceptable to the user. The prediction may also be improved by assigning different values to the training data items according to the context in which the user provided feedback, enabling the training to differently-label positive and negative training items based on whether the customer accepted or rejected the candidate item in conjunction with other items.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example; comparing an output of the machine-learning model to the label associated with the training example; and updating weights associated for the machine-learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving an order placed by a user for a fulfillment by a picker at a physical location, wherein the order includes an ordered item that is unavailable for fulfillment by the picker at the physical location;
accessing a set of contextual features about the order placed by the user;
computing a score for each of a plurality of candidate replacement items by applying a machine learning model to the set of contextual features, wherein the machine learning model is trained to output a score that represents a likelihood that the user would accept the candidate replacement item for the order;
selecting a candidate replacement item of the plurality of candidate replacement items based on the scores; and
causing the selected candidate replacement item to be displayed as a suggested replacement item for the ordered item.

2. The method of claim 1, wherein accessing the set of contextual features comprises accessing one or more features based on other items in the order different from the ordered item.

3. The method of claim 2, wherein computing a score for each of a plurality of candidate replacement items includes applying a bag-of-words model with the set of contextual features based on other items in the order different from the ordered item.

4. The method of claim 1, wherein accessing the set of contextual features comprises accessing one or more user features describing characteristics of the user.

5. The method of claim 1, wherein accessing the set of contextual features comprises accessing one or more user features describing prior orders of the user.

6. The method of claim 1, wherein accessing the set of contextual features includes accessing features describing a real-time conversation with the user based on natural-language processing of the real-time conversation.

7. The method of claim 1, further comprising:
receiving an indication that the ordered item is unavailable for fulfillment by the picker at the physical location, wherein the indication is received from a device of the picker located at the physical location during the fulfillment of the order.

8. The method of claim 1, wherein causing the selected candidate replacement item to be displayed comprises causing the selected candidate replacement item to be displayed on a device of the picker.

9. The method of claim 1, further comprising:
labeling a set of training data of candidate replacement items and associated contextual features based on observed user interactions with the candidate replacement items; and
re-training the machine learning model based on the labeled set of training data.

10. A non-transitory computer readable storage medium having instructions encoded thereon that, when executed by a processor, cause the processor to perform steps comprising:
receiving an order placed by a user for a fulfillment by a picker at a physical location, wherein the order includes an ordered item that is unavailable for fulfillment by the picker at the physical location;
accessing a set of contextual features about the order placed by the user;
computing a score for each of a plurality of candidate replacement items by applying a machine learning model to the set of contextual features, wherein the machine learning model is trained to output a score that represents a likelihood that the user would accept the candidate replacement item for the order;
selecting a candidate replacement item of the plurality of candidate replacement items based on the scores; and
causing the selected candidate replacement item to be displayed as a suggested replacement item for the ordered item.

11. The non-transitory computer readable storage medium of claim 10, wherein accessing the set of contextual features comprises accessing one or more features based on other items in the order different from the ordered item.

12. The non-transitory computer readable storage medium of claim 11, wherein computing a score for each of a plurality of candidate replacement items includes applying a bag-of-words model with the set of contextual features based on other items in the order different from the ordered item.

13. The non-transitory computer readable storage medium of claim 10, wherein accessing the set of contextual features comprises accessing one or more user features describing characteristics of the user.

14. The non-transitory computer readable storage medium of claim 10, wherein accessing the set of contextual features comprises accessing one or more user features describing prior orders of the user.

15. The non-transitory computer readable storage medium of claim 10, wherein accessing the set of contextual features includes accessing features describing a real-time conversation with the user based on natural-language processing of the real-time conversation.

16. The non-transitory computer readable storage medium of claim 10, wherein the instructions, when executed by the processor, further cause the processor to perform steps comprising:
receiving an indication that the ordered item is unavailable for fulfillment by the picker at the physical location, wherein the indication is received from a device of the picker located at the physical location during the fulfillment of the order.

17. The non-transitory computer readable storage medium of claim 10, wherein causing the selected candidate replacement item to be displayed comprises causing the selected candidate replacement item to be displayed on a device of the picker.

18. The non-transitory computer readable storage medium of claim 10, wherein the instructions, when executed by the processor, further cause the processor to:
labeling a set of training data of candidate replacement items and associated contextual features based on observed user interactions with the candidate replacement items; and
re-training the machine learning model based on the labeled set of training data.

19. A computer program product, comprising:
a processor that executes instructions; and
a non-transitory computer readable storage medium having instructions executable by the processor for:
receiving an order placed by a user for a fulfillment by a picker at a physical location, wherein the order includes an ordered item that is unavailable for fulfillment by the picker at the physical location;
accessing a set of contextual features about the order placed by the user;
computing a score for each of a plurality of candidate replacement items by applying a machine learning model to the set of contextual features, wherein the machine learning model is trained to output a score that represents a likelihood that the user would accept the candidate replacement item for the order;
selecting a candidate replacement item of the plurality of candidate replacement items based on the scores; and
causing the selected candidate replacement item to be displayed as a suggested replacement item for the ordered item.

20. The computer program product of claim 19, wherein accessing the set of contextual features comprises accessing one or more features based on other items in the order different from the ordered item.
